(19) United States
(12) Patent Application Publication
(10) Pub. No.: US 2007/0022286 A1
(43) Pub. Date: Jan. 25, 2007

(54) Method and apparatus for providing a multi-user encrypted environment

(75) Inventor: Mohamed Makni, Montreal (CA)

Correspondence Address: OGILVY RENAULT LLP, 1981 MCGILL COLLEGE AVENUE, SUITE 1600, MONTREAL, QC, H3A2Y3, CA

(73) Assignee: LANISTE, INC.

(21) Appl. No.: 11/185,946

(22) Filed: Jul. 21, 2005

(51) Int. Cl. H04L 9/32; G06F 15/16; H04L 9/00; G06K 9/00; G06F 17/00; G06F 17/30; G06F 9/00; G06F 7/04; G06F 7/58; G06K 19/00

(52) U.S. Cl. 713/163; 726/15; 726/4

(57) ABSTRACT

A method and system are disclosed for providing a multi-user encrypted environment to each of a plurality of user groups. Each user group has a plurality of corresponding users. The system comprises a plurality of virtual network interface cards, each for authenticating and communicating according to a corresponding encryption scheme. The system further comprises a user group database associating each of the plurality of virtual network interface cards to a given user. The system also comprises a routing unit connected to the plurality of virtual network interface cards and to the user group database for dynamically associating a given user of a given user group to a corresponding virtual network interface card according to the user group database to thereby provide the corresponding encrypted environment.

### CROSS-REFERENCE TO RELATED APPLICATIONS

This is the first application filed for the present invention.

### TECHNICAL FIELD

This invention relates to the field of communications. More precisely, the invention pertains to encrypted communications.

### BACKGROUND OF THE INVENTION

As communications are increasing between individuals and corporations, requirements for encrypting communications are now becoming more and more obvious for securing the communications.

In fact, eavesdropping of a communication between at least two parties may be avoided using pertinent encryption as well as authentication schemes.

For instance, Virtual Private Networks (VPN) enable the securing of a communication between at least one user and a corresponding server. Unfortunately, implementing a Virtual Private Network requires extra resources which may be to much of a burden for a small organization.

### SUMMARY OF THE INVENTION

According to an aspect of the invention, there is provided a system for providing a multi-user encrypted environment to each of a plurality of user groups, each user group having a plurality of corresponding users, the system comprising a plurality of virtual network interface cards, each for authenticating and communicating according to a corresponding encryption scheme, a user group database associating each of the plurality of virtual network interface cards to a given user, a routing unit connected to the plurality of virtual network interface cards and to the user group database for dynamically associating a given user of a given user group to a corresponding virtual network interface card according to the user group database to thereby provide the corresponding encrypted environment.

According to another aspect of the invention, there is provided a method for providing a multi-user encrypted environment to each of a plurality of user groups, each user group having a plurality of corresponding users, the method comprising creating a plurality of virtual network interface cards each for a user group, each for authenticating and communicating according to a corresponding encryption scheme and creating a routing system connected to the created plurality of virtual network interface cards for dynamically associating a given user of a given user group to a corresponding virtual network interface card to thereby provide the corresponding encrypted environment.

### BRIEF DESCRIPTION OF THE DRAWINGS

Further features and advantages of the present invention will become apparent from the following detailed description, taken in combination with the appended drawings, in which:

FIG. 1 is a diagram wherein a multi-user encrypted environment providing unit is advantageously used;

FIG. 2 is a diagram showing a first embodiment of a multi-user encrypted environment providing unit;

FIG. 3 is a diagram showing a second embodiment of a multi-user encrypted environment providing unit which is used to access a plurality of services using a user service database;

FIG. 4 is a flowchart showing how the multi-user encrypted environment providing unit may be used; according to a first step, a connection to the multi-user encrypted environment is performed; according to a second step, a session is setup and according to a third step, the setup session is used to access a service;

FIG. 5 is a flowchart showing how the connection to the multi-user encrypted environment is performed;

FIG. 6 is a flowchart showing how the session is setup;

FIG. 7 is a flowchart showing how the setup session is used to access a service;

FIG. 8 is a flowchart showing how a multi-user encrypted environment may be created according to an embodiment; according to a first step a given number of authentication units is created, according to a second step a given number of communication units is created according to the created number of authentication units and according to a third step, a routing system is created;

FIG. 9 is a flowchart showing how the given number of authentication units is created;

FIG. 10 is a flowchart showing how the given number of communication units is created; and

FIG. 11 is a flowchart showing how the routing system is created.

It will be noted that throughout the appended drawings, like features are identified by like reference numerals.

### DETAILED DESCRIPTION OF THE PREFERRED EMBODIMENT

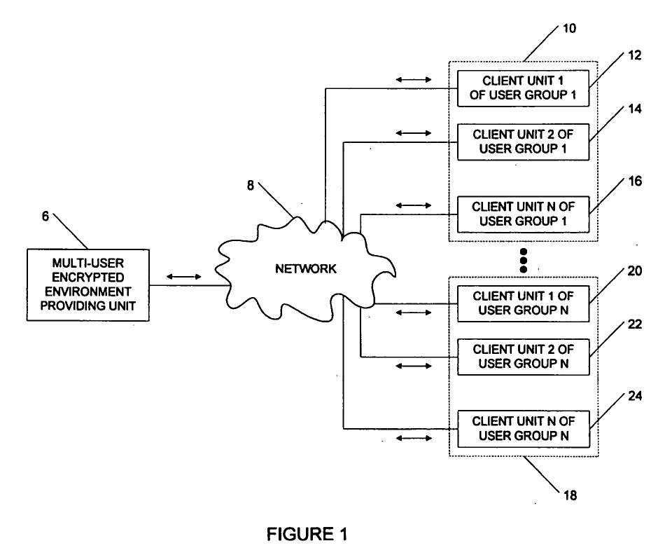

Now referring to FIG. 1, there is shown an embodiment in which a multi-user encrypted environment providing unit 6 is advantageously used.

In this embodiment, a plurality of client units corresponding to a plurality of user groups are communicating using the multi-user encrypted environment providing unit 6 via a network 8.

More precisely and as shown in FIG. 1, a first user group 10 comprises client unit 1 (12), client unit 2 (14) and client unit N (16) is communicating with the multi-user encrypted environment providing unit 6 via the network 8. User group N (18), comprising client unit 1 (20), client unit 2 (22) and client unit N (24), is communicating with the multi-user encrypted environment providing unit 6 via the network 8.

At this point it should be understood that a user group may be defined as any group of users. For instance, the user group may be anyone of an association of users, a corporation, a division or department of a corporation or the like.

In one embodiment, the network 8 may be any one of a local area network (LAN), a metropolitan area network (MAN) and a wide area network (WAN). In a preferred embodiment of the invention, the network 8 comprises the Internet.

Each client unit of a corresponding user group comprises a processing unit suitable for communicating with the multi-user encrypted environment providing unit 6 via the network 8. The skilled addressee will appreciate that a large variety of processing units may be used to access the multi-user encrypted environment providing unit 6 via the network 8, such as a desktop computer, a laptop, a personal digital assistant (PDA), a smartphone or the like. In a preferred embodiment, the client unit is a computer.

The multi-user encrypted environment providing unit 6 is adapted to provide an encrypted environment to each client unit of a plurality of user groups. In a preferred embodiment, the multi-user encrypted environment providing unit 6 is implemented on a computer running Linux. The computer comprises a standalone PC having a single processor, 128 MB of Random Access Memory (RAM) and 2 GB of available space on a hard drive.

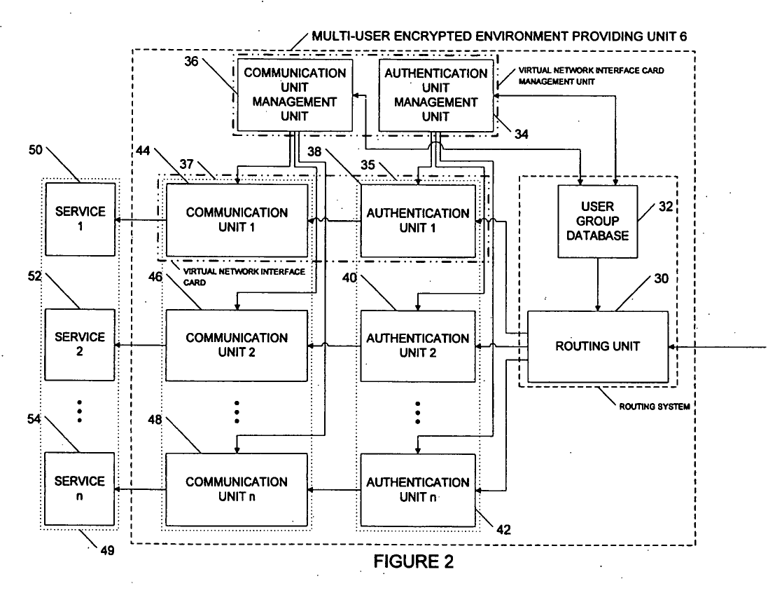

Now referring to FIG. 2, there is shown a first embodiment of a multi-user encrypted environment providing unit 6.

The multi-user encrypted environment providing unit 6 comprises a routing unit 30, a user group database 32, an authentication unit management unit 34, a communication unit management unit 36, a plurality of authentication units 35 and a plurality of communication units 37.

It will be appreciated that an authentication unit and a corresponding communication unit may be one instance of a virtual network interface card.

It will be appreciated that the communication unit management unit 36 and the authentication unit management unit 34 may be one instance of a virtual network interface card management unit.

The plurality of authentication units 35 comprise, in the embodiment disclosed in FIG. 2, a first authentication unit 38, a second authentication unit 40 and an n^{th} authentication unit 42.

The plurality of communication units 37 comprise in the embodiment disclosed in FIG. 2, a first communication unit 44, a second communication unit 46, and an nth communication unit 48.

The multi-user encrypted environment 6 is connected to the network 8 and to a plurality of services 49. The plurality of services 49 comprises in the embodiment disclosed in FIG. 2, a first service 50, a second service 52 and an nth service 54.

The authentication unit management unit 34 is used to create and manage each of the plurality of authentication units 35 while the communication unit management unit 36 is used to create and manage each of the plurality of communication units 37.

The user group database 32 comprises information enabling the routing unit 30 to route an incoming data signal to a corresponding authentication unit of the plurality of authentication units 35.

As explained below, each authentication unit of the plurality of authentication units 35 is used to authenticate a user of a given user group. The skilled addressee will therefore appreciate that at least three authentication units are required in the case where users from three different user groups intend to use the multi-user encrypted environment 6.

The routing unit 30 is used to route an incoming data signal to a given authentication unit of the plurality of authentication units 35 using the user group database 32. It will be appreciated that the routing unit 30 may be accessed using a given Internet address in the case where the network 8 comprises the Internet.

Each authentication unit of the plurality of authentication units 35 is used to authenticate each user of a given user group. It will be appreciated by the skilled addressee that each authentication unit accesses a corresponding database of login and password for a given user group not shown in the drawings for clarity purposes. It should be further appreciated that in one embodiment, the database is implemented using Postresql. Furthermore, it will be appreciated that each authentication unit may operate according to a virtual private network (VPN) encryption scheme.

As shown in FIG. 2, each communication unit of the plurality of communication units 37 is connected to a corresponding authentication unit and is used to provide a given service to an authenticated user of a given user group.

It will be appreciated that a plurality of services may be connected to each communication unit of the plurality of communication units 37. For instance the plurality of services may be selected from a group consisting of network applications (such as email clients, file transfer protocol (FTP) client, Telnet clients, web browser, or the like), office applications (such as spreadsheet programs, calculators, etc.) or any other suitable service that may advantageously used by a given user.

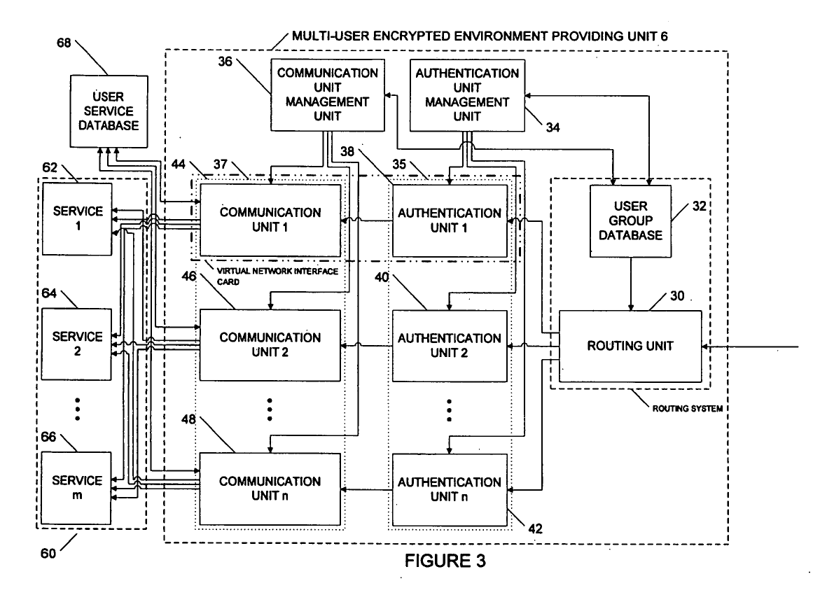

Now referring to FIG. 3, there is shown another embodiment where the multi-user encrypted environment providing unit 6 may be advantageously used to access a plurality of services 60 according to a user service database 68.

More precisely, each communication unit of the plurality of communication unit 37 may access a service following a proper identification using the user service database 68. The skilled addressee will appreciate that such providing scheme is of great advantage as common services may be used by a plurality of communication units.

In this embodiment disclosed in FIG. 3, the plurality of services 60 comprises a first service 62, a second service 64, and an m^{th} service 66.

While this has not been shown in the drawings for clarity purposes, the skilled addressee will appreciate that a user service database management unit may be required in order to create and manage the user service database 68.

At this point it should be understood by the skilled addressee that various implementations are possible.

For instance, in one embodiment, the plurality of services 60 may be implemented within at least one virtual server.

Alternatively, it will be appreciated that each authentication unit, its corresponding communication unit and its corresponding service may be implemented in a virtual environment.

It will be appreciated that in an alternative embodiment an authentication unit may be connected to a plurality of corresponding communication units.

Alternatively, a plurality of authentication units may be connected to a single communication unit.

Also, while this has not been disclosed in the drawings, it should be understood that while a first given communication unit may be used to handle an incoming communication signal, a second given communication unit may be used to handle an outgoing communication signal.

Also the communication unit may be alternatively, bonded to any type of communication port such as for instance an IEEE 1394 (FireWire) port, a Bluetooth port, a WiFi port or the like.

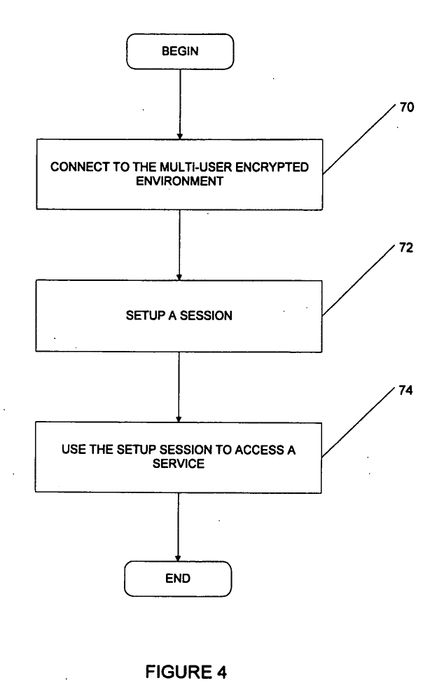

Now referring to FIG. 4, there is shown an embodiment for using the multi-user encrypted environment providing unit 6.

According to step 70, a connection to the multi-user encrypted environment providing unit 6 is performed.

According to step 72, a session is setup with the multi-user encrypted environment providing unit 6.

According to step 74, the setup session is used to access a given service of the multi-user encrypted environment providing unit 6.

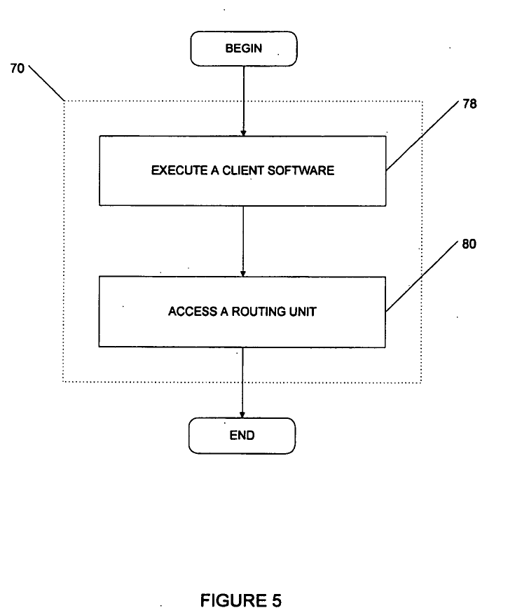

Now referring to FIG. 5, there is shown an embodiment for creating a connection with the multi-user encrypted environment providing unit 6.

According to step 78, a client software is executed, it will be appreciated that the client software may be downloaded on a client unit of a user group from a website for a given fee in one embodiment. The skilled addressee will appreciate that, alternatively, such client software may be also provided using a recording media such as a CD-ROM, a DVD, or the like. It will be further appreciated that the client software may be already configured in one embodiment.

In the case where a fee is paid for having the client software it will be appreciated that various techniques, known to the skilled addressee, may be used to order/purchase the client software.

According to step 80, an access is performed to the routing unit 30 of the multi-user encrypted environment providing unit 6. In a preferred embodiment, the access is performed via the network 8. It will be appreciated that in one embodiment, the performing of the access comprises entering an address of the multi-user encrypted environment providing unit 6 in the network 8. Alternatively, the address of the multi-user encrypted environment providing unit 6 is already comprised in the client software.

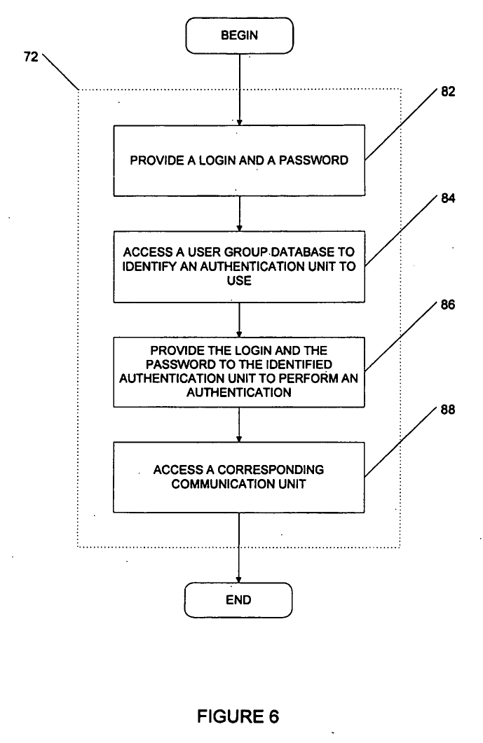

Now referring to FIG. 6, there is shown how a session is setup with the multi-user encrypted environment providing unit 6.

According to step 82, a login and a password are provided. The login and the password are provided by a given user of a given client unit comprised in a given user group.

According to step 84, a user group database 32 is accessed to identify a proper authentication unit of the plurality of authentication units 35 to use. It will be appreciated that the user group database is accessed by the routing unit 30. In one embodiment, the user group database 32 is accessed using a domain name address such as usergroup.provider.com.

According to step 86, the login and password are provided to the identified suitable authentication unit that is to be used to perform an authentication for a given user group.

According to step 88, a corresponding communication unit connected to the identified authentication unit is accessed. It will be appreciated that the access to the corresponding communication unit is only performed in the case where the authentication is successful. The skilled addressee will appreciate that at this point a secure session is set up between the user and the multi-user encrypted environment providing unit 6.

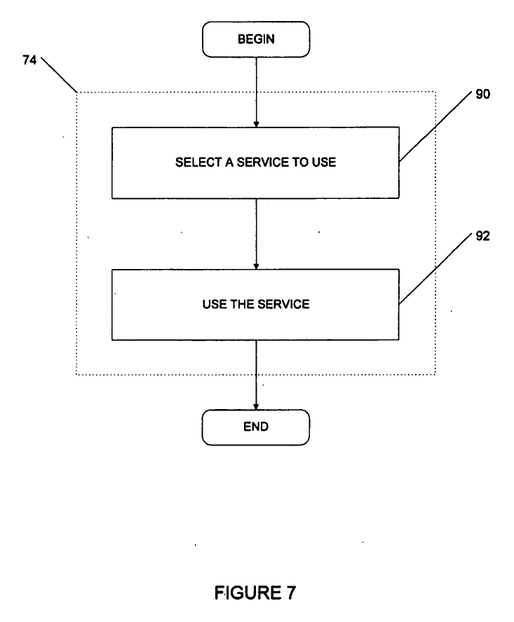

Now referring to FIG. 7, there is shown an embodiment which shows how the setup session is used to access a service of the plurality of services 60.

According to step 90, a service to use is selected. The skilled addressee will appreciate that depending on a user group and also depending on a client unit, at least one service may be available. The service to use is preferably selected by the user. Alternatively, the service to use may be automatically selected and launched.

According to step 92, the selected service to use is used. It will be appreciated by the skilled addressee that a plurality of services may be concurrently run by a client unit.

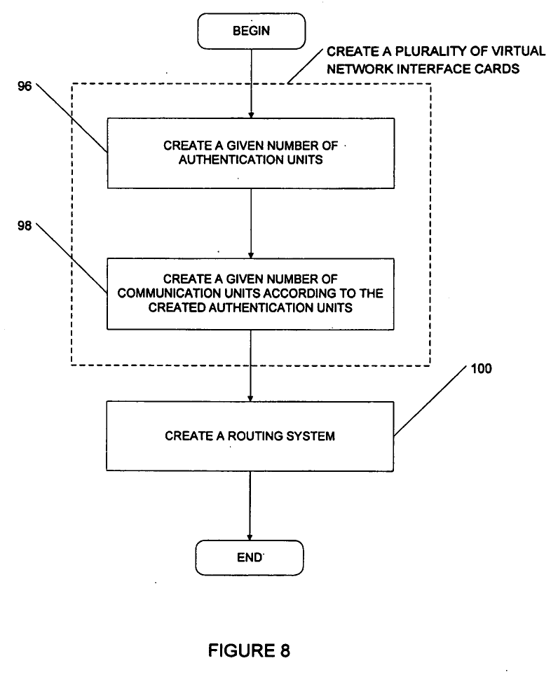

Now referring to FIG. 8, there is shown an embodiment for creating a multi-user encrypted environment providing unit 6.

According to step 96, a given number of authentication units is created. As explained above, it will be appreciated that at least one authentication unit is created for a user group.

According to step 98, a given number of communication units is created according to the given number of authentication units created.

It will be appreciated by the skilled addressee that steps 96 and 98 are one embodiment of the creation of a plurality of virtual network interface cards each for a user group, each for authenticating and communicating according to a corresponding Virtual Private Network (VPN) scheme.

According to step 100, a routing system is created. It will be appreciated that the routing system is created for dynamically associating a given user of a given user group to a corresponding virtual network interface card.

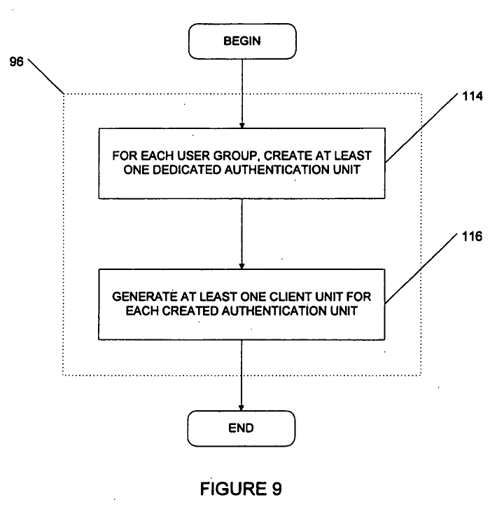

Now referring to FIG. 9, there is shown an embodiment for creating a given number of authentication unit.

According to step 114, a dedicated authentication unit is created for each user group.

In one embodiment, a virtual network card is generated to create the dedicated authentication unit.

The skilled addressee will appreciate that the virtual network card is created as follows under a Unix system

(1) go to directory/etc/sysconfig/network;

(2) for each virtual card to create, create a new file ifcfg-ethX:Y, wherein X is the number of the real card and Y is the number of the virtual interface linked to the real card;

(3) add the following to the file:

BOOTPROTO=static

NETMASK=255.255.255.0

MTU=″″

BROADCAST=XXX.XXX.XXX.255

UNIQUE=YYYYYYYY

IPADDR=XXX.XXX.XXX.XXX

STARTMODE=onboot

NETWORK=XXX.XXX.XXX.0

(4) reload

According to step 116, at least one client unit is generated for each dedicated authentication unit. The skilled addressee will appreciate that a plurality of users may then be created for the dedicated authentication unit by the at least one client unit generated.

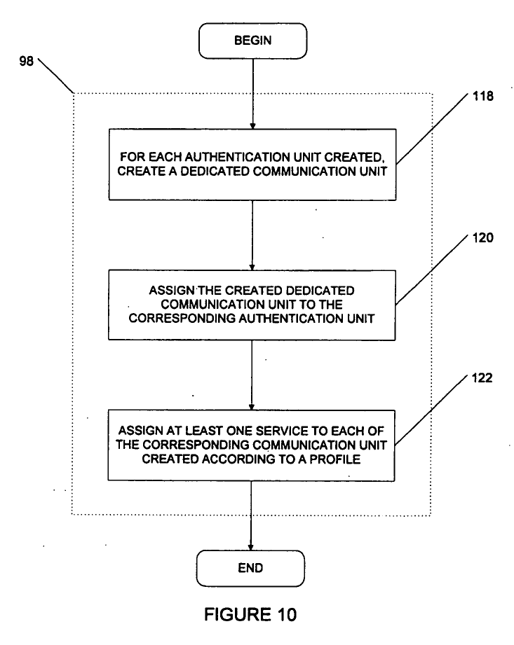

Now referring to FIG. 10, there is shown an embodiment for creating a given number of communication units according to the created authentication units.

According to step 118, a dedicated communication unit is created for each authentication unit created.

In one embodiment, a virtual network interface card is generated to create the dedicated communication unit. The virtual network interface card is created as explained above.

According to step 120, each of the created dedicated communication unit is assigned to a corresponding authentication unit.

According to step 122, at least one service is assigned to each of the corresponding communication unit created according to a profile. It should be understood by the skilled addressee that the profile may be user-based or user group-based.

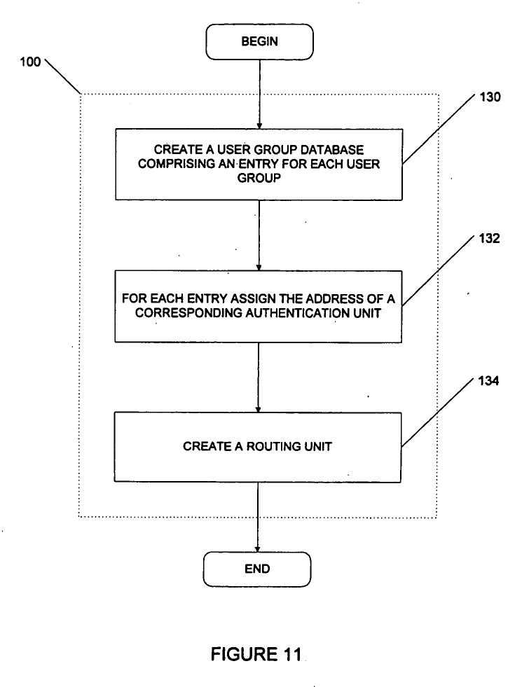

Now referring to FIG. 11, there is shown an embodiment for creating a routing system.

According to step 130, a user group database comprising an entry for each user group is created. In one embodiment the user group database is created using Postgresql or any other database.

According to step 132, for each entry of a given user group in the database, the address of a corresponding authentication unit to use is provided.

According to step 134, a routing unit is created. The routing unit is connected to the user group database and is able to route incoming traffic to a suitable authentication unit depending on a user group. In one embodiment, the routing unit operates using DNS or Internet Protocol (IP) address.

As explained above, the routing system may comprise in one embodiment a user group database and a routing unit operating with the user group database.

The skilled addressee will appreciate that the disclosed multi-user encrypted environment enables to create dynamically a plurality of encrypted environments each for a given user group. Moreover, it will be appreciated that such multi-user encrypted environment may be provided on a single server which is again of great advantage. The skilled addressee will further appreciated that scalability may be easily achieved if required. Also it will be appreciate that many client units may be run on a single computer for instance.

The skilled addressee will appreciate that a Virtual Private Network is an example of an encryption scheme.

It will be appreciated that a fee may be charged for using the multi-user encrypted environment. For instance, at least one of a per-use fee and an access fee may be charged depending on various considerations.

While it has not been disclosed, the skilled addressee will understand that at least one firewall may be used in the multi-user encrypted environment providing unit 6. More precisely, in one embodiment, a firewall may be provided for each authentication unit while in another embodiment, a single firewall may be provided for the plurality of authentication units.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium or an electrical or electro-magnetical signal.

The embodiments of the invention described above is(are) intended to be exemplary only. The scope of the invention is therefore intended to be limited solely by the scope of the appended claims.

I claim:

1. A system for providing a multi-user encrypted environment to each of a plurality of user groups, each user group having a plurality of corresponding users, said system comprising:
a plurality of virtual network interface cards, each for authenticating and communicating according to a corresponding encryption scheme;
a user group database associating each of the plurality of virtual network interface cards to a given user group; and
a routing unit connected to said plurality of virtual network interface cards and to said user group database for dynamically associating a given user of a given user group to a corresponding virtual network interface card according to said user group database to thereby provide said corresponding encrypted environment.

2. The system as claimed in claim 1, further comprising a virtual network interface card management unit for managing each of said plurality of virtual network interface card.

3. The system as claimed in claim 1, wherein each of said plurality of virtual network interface cards comprises an authentication unit for authenticating and a corresponding communication unit for communicating according to a corresponding encryption scheme.

4. The system as claimed in claim 3, further comprising an authentication unit management unit for managing each of said authentication units.

5. The system as claimed in claim 4, further comprising a communication unit management unit for managing each of said communication units.

6. The system as claimed in claim 1, wherein each of said plurality of virtual network interface cards comprises an authentication unit for authenticating and at least two corresponding communication units each for communicating according to a corresponding encryption scheme.

7. The system as claimed in claim 6, further comprising an authentication unit management unit for managing each of said authentication units.

8. The system as claimed in claim 7, further comprising a communication unit management unit for managing each of said communication units.

9. The system as claimed in claim 1, wherein each of said plurality of virtual network interface cards comprises at least two authentication units each for authenticating and a corresponding communication unit for communicating according to a corresponding encryption scheme.

10. The system as claimed in claim 9, further comprising an authentication unit management unit for managing each of said authentication units.

11. The system as claimed in claim 10, further comprising a communication unit management unit for managing each of said communication units.

12. The system as claimed in claim 1, wherein said encryption scheme comprises a Virtual Private Network (VPN) scheme.

13. A method for providing a multi-user encrypted environment to each of a plurality of user groups, each user group having a plurality of corresponding users, said method comprising:
creating a plurality of virtual network interface cards each for a user group, each for authenticating and communicating according to a corresponding encryption scheme; and
creating a routing system connected to said created plurality of virtual network interface cards for dynamically associating a given user of a given user group to a corresponding virtual network interface card to thereby provide said corresponding encrypted environment.

14. The method as claimed in claim 13, wherein said creating of said plurality of virtual network interface cards comprises creating a plurality of authentication units for authenticating and a corresponding plurality of communication units for communicating according to a corresponding encryption scheme.

15. The method as claimed in claim 13, wherein said creating of said routing system comprises creating a user group database comprising an entry for each user group and its corresponding virtual network interface card and creating a routing unit connected to said user group database for dynamically associating a given user of a given user group to a corresponding virtual network interface.

16. A method for using a multi-user encrypted environment created according to the method as claimed in any one of claim 13.

17. A method of doing business wherein the using of a multi-user encrypted environment created according to the method as claimed in any one of claim 13 is done for a fee.

18. A computer readable memory adapted to store instructions which when executed create the multi-user encrypted environment claimed in any one of claim 13.
